(19) United States
(12) Patent Application Publication
(10) Pub. No.: US 2025/0039250 A1
(43) Pub. Date: Jan. 30, 2025

(54) CALL ELEVATION IN HYBRID MIXER WITH BACK-TO-BACK AND GROUP CALL CAPABILITIES

(71) Applicant: Microsoft Technology Licensing, LLC, Redmond, WA (US)

(72) Inventors: Isaiah Michael MAYERCHAK, Bellevue, WA (US); Abhilash Chandrasekharan NAIR, Bothell, WA (US); Marc-Aurele CHARPENTIER-PODREZ, Woodinville, WA (US); Kensaku SUEDA, Portland, OR (US)

(73) Assignee: Microsoft Technology Licensing, LLC, Redmond, WA (US)

(21) Appl. No.: 18/226,168

(22) Filed: Jul. 25, 2023

(51) Int. Cl. H04L 65/1089; H04L 65/1069; H04L 65/1093; H04L 65/401; H04L 65/613

(52) U.S. Cl. CPC H04L 65/1089; H04L 65/1069; H04L 65/1093; H04L 65/401; H04L 65/613

(57) ABSTRACT

Techniques are described for elevating calls with a hybrid mixer that combines the functionality of a back-to-back (B2B) mixer and a group call (GC) mixer to enable early media flow during call setup. Upon detecting initiation of a call, a call service determines that elevation of the call to add an additional participant is advised and internally spawns a hybrid B2B/GC mixer. The additional participant is added to the hybrid mixer, and then the caller and callee are sequentially added to the hybrid mixer. The additional participant can be a recording application or another call participant. The hybrid mixer processes intercepted communications sent between the caller and callee throughout the call setup process to maintain their B2B relationship.

### BACKGROUND

The process of transforming a call between two users with a peer-to-peer (P2P) connection into a call with media hosted by a group call (GC) mixer can be referred to as “escalation” of the call. Call escalation is generally accomplished by establishing a connection between each user and the GC mixer, then requesting that each user switch from communicating over their P2P connection and instead use the connection to the GC mixer. At this point, additional entities can be added to the GC mixer.

In contrast, transforming a call between two users into a call with media hosted by a GC mixer during a call setup process, before the P2P connection is established, can be referred to as “elevation” of the call. Call elevation is faster and more reliable than first establishing a P2P connection and then retargeting each user to a GC mixer. Accordingly, if a runtime decision is made that a call will involve more participants immediately after initial call establishment, it can be advantageous to elevate, rather than escalate, the call. Further advantages of call elevation include the ability for the service provider hosting the call to insert entities into a call such that the entities are present before the original caller and callee are connected to each other. An example of this is policy-based compliance recording, in which the service provider inserts a recording application (sometimes referred to as a “recording bot”) into a call before the caller and callee are connected. This allows the recording application to capture the entirety of the conversation between the two users, in compliance with a policy in place for the caller and/or callee.

However, one major disadvantage of call elevation is that early media flow (e.g., for interactive voice response (IVR) prompts and custom ringtones) is not supported. Because the call is hosted by a GC mixer during elevation, enabling early media to flow through the GC mixer during call setup between the two users entails allowing early media to potentially flow to any GC call participant. This can cause privacy concerns (e.g., a caller inputting personal information such as a credit card number) and introduce annoyances (e.g., because early media is often only relevant to very few users, typically the caller and a recording application).

In a “back-to-back” (B2B) configuration, a middle service mediates communications between a caller and callee in order to emulate a P2P connection between the caller and callee. Another disadvantage of call elevation is that it can lead to loss of the B2B flow between the caller and the callee. This B2B flow ensures that the caller's experience mimics the experience the caller would have when making a P2P call (e.g., ensuring that call setup only completes when the callee answers the call). In a GC mixer, caller and callee's legs are independent, such that in any given call setup, either the caller or the callee might connect to the GC mixer first. As a result, in some situations, the caller or the callee might have a strange user experience which is inconsistent with the P2P expectation that the caller has directly called the callee. For example, the caller's call setup might complete very fast because the GC mixer will “answer” almost immediately, at which point the caller would feel like the call was answered (e.g., ringing would stop, and the user interface (UI) would change). If using a calling application, the caller would see the call as connected potentially before the callee even started ringing. If the caller is connected before the callee, the caller would hear silence until the callee starts sending early media or, if no early media is used, until the callee connects as well. In contrast, the desired behavior is for the caller to hear ringing up until the callee starts sending early media or answers the call. Another issue arises when the callee starts sending media (early or not) before the caller is able to receive it, which can lead to loss of early media from the perspective of the caller (e.g., clipped audio). As a result, certain features and experiences associated with early media flow are not available when elevation is used.

### SUMMARY

In summary, the detailed description presents innovations in call elevation, in the context of a call service, which utilize a hybrid B2B/GC mixer. The hybrid B2B/GC mixer can mix audio and/or video and broadcast it to all participants of a call, much like a GC mixer, while also including functionality associated with a B2B mixer (e.g., the ability to maintain the special B2B relationship between the caller and callee in which call signaling creates the impression of a one-to-one flow). A media controller service of the call service can internally spawn (e.g., create or initialize) the hybrid B2B/GC mixer to facilitate a specialized form of call elevation. In this specialized form of call elevation, the B2B relationship between the original caller and callee is maintained when the original caller and callee are added to the hybrid B2B/GC mixer, whereas other call participants (such as recording applications) are added to the mixer as regular GC participants which are not part of the B2B relationship. This in turn can allow all participants present at the beginning of a call to hear any early media provided by the callee. For example, the participants present at the beginning of the call include the caller, the callee, and a recording application but do not include later-added GC participants. Accordingly, the hybrid B2B/GC mixer can make it possible for features that rely on or are optimized by call elevation (e.g., compliance recording applications) to function with early media flow.

For the sake of brevity, the hybrid B2B/GC mixer is alternatively referred to herein as a “hybrid mixer.” While the hybrid mixer is described herein as being internally spawned by a media controller service of the call service, the hybrid mixer can alternatively be a separate server-side component (e.g., a hardware device) which is configured to perform the same operations.

The innovations described herein can be implemented as part of a method, as part of a computing system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a diagram illustrating an example computing system in which some described embodiments can be implemented.

FIG. 2 is a diagram of an example network environment in which some described embodiments can be implemented.

FIGS. 3A-C is an example processing flow for performing call elevation using a hybrid B2B/GC mixer.

FIGS. 4-6 are flowcharts illustrating generalized techniques for call elevation in accordance with some of the described embodiments.

### DETAILED DESCRIPTION

The detailed description presents innovations in call elevation which utilize a hybrid B2B/GC mixer to enable early media flow during call setup. In particular, a media controller service of a call service (e.g., a conference call service) can internally spawn a hybrid mixer which is configured to perform operations associated with a regular GC mixer (e.g., mixing audio and/or video and broadcasting it to all participants of a call) as well as operations associated with a regular B2B mixer (e.g., maintaining the B2B flow between the original caller and callee such that their experience mimics a P2P call).

The technologies described herein provide technical solutions to the technical problems associated with elevating a call between a caller and a callee to add another participant, such as a recording application. One such technical problem involves the lack of support for early media flow (e.g., for IVR prompts and custom ringtones) in existing call elevation procedures, such that certain features and experiences associated with early media flow are not available when call elevation is used. Another technical problem associated with elevating a call between a caller and a callee to add another participant is that call elevation can lead to the loss or degradation of the B2B flow between the caller and the callee, such that the caller's experience no longer mimics the experience the caller would have when making a P2P call. Technical solutions to these problems provided by the technologies disclosed herein include a call service internally spawning a hybrid mixer configured to perform operations associated with a B2B mixer as well as operations associated with a GC mixer. The hybrid mixer can mix audio and/or video and broadcast it to all participants of a call, much like a GC mixer, while also including functionality associated with a B2B mixer. In particular, the hybrid mixer facilitates a specialized form of call elevation in which the B2B relationship between the original caller and callee is maintained when the caller and callee are added to the hybrid mixer, whereas other participants such as recording applications are added to the mixer as regular GC participants which are not part of the B2B relationship. This in turn allows all participants present at the beginning of a call, for example, including the original caller and a recording application, to hear any early media provided by the callee. Accordingly, the technologies disclosed herein provide technical advantages, such as making it possible for features that rely on or are optimized by call elevation (e.g., compliance recording applications) to function without sacrificing early media flow. Additional technical advantages provided by the technologies disclosed herein include preservation of a desirable user experience for the caller and callee that mimics a P2P call.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. Example Computer Systems.

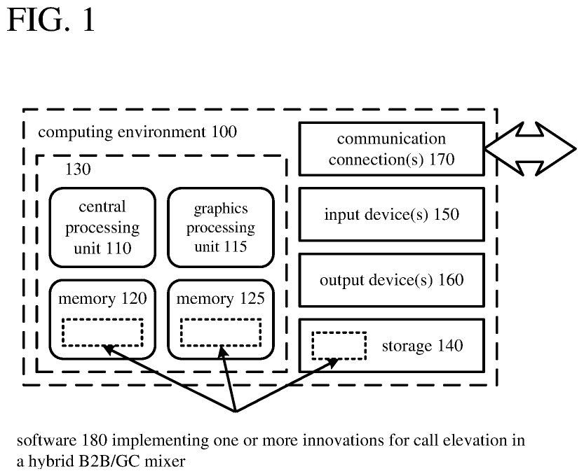

FIG. 1 illustrates a generalized example of a suitable computer system (100) in which several of the described innovations may be implemented. The innovations described herein relate to employing a hybrid mixer for call elevation to enable early media flow during call setup. The computer system (100) is not intended to suggest any limitation as to scope of use or functionality, as the innovations may be implemented in diverse computer systems, including special-purpose computer systems.

With reference to FIG. 1, the computer system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a CPU (110) as well as a graphics processing unit (“GPU”) (115). In general, the GPU (115) is any specialized circuit, different from the CPU (110), that accelerates creation and/or manipulation of image data in a graphics pipeline. The GPU (115) can be implemented as part of a dedicated graphics card (video card), as part of a motherboard, as part of a system on a chip (“SoC”), or in some other way (even on the same die as the CPU (110)).

The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for call elevation utilizing a hybrid B2B/GC mixer, in the form of computer-executable instructions suitable for execution by the processing unit(s).

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, operating system (“OS”) software (not shown) provides an operating environment for other software executing in the computer system (100), and coordinates activities of the components of the computer system (100).

The tangible storage (140) may be removable or non-removable, and includes magnetic storage media such as magnetic disks, magnetic tapes or cassettes, optical storage media such as CD-ROMs or DVDs, or any other medium which can be used to store information and which can be accessed within the computer system (100). The storage (140) can store instructions for the software (180) implementing one or more innovations for call elevation utilizing a hybrid B2B/GC mixer.

The input device(s) (150) may be a touch input device such as a keyboard, mouse, pen, or trackball, a voice input device, a scanning device, or another device that provides input to the computer system (100). For video, the input device(s) (150) may be a camera, video card, screen capture module, TV tuner card, or similar device that accepts video input in analog or digital form, or a CD-ROM or CD-RW that reads video input into the computer system (100). The output device(s) (160) may be a display, printer, speaker, CD-writer, or another device that provides output from the computer system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computer system (100), computer-readable media include memory (120, 125), storage (140), and combinations thereof. As used herein, the term computer-readable media does not include transitory signals or propagating carrier waves.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or computer device can be local or distributed, and can include any combination of special-purpose hardware and/or general-purpose hardware with software implementing the functionality described herein.

For the sake of presentation, the detailed description uses terms like “determine” and “perform” to describe computer operations in a computer system. These terms are high-level abstractions for operations performed by a computer, and should not be confused with acts performed by a human being. The actual computer operations corresponding to these terms vary depending on implementation.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps/stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

### II. Example Network Environment.

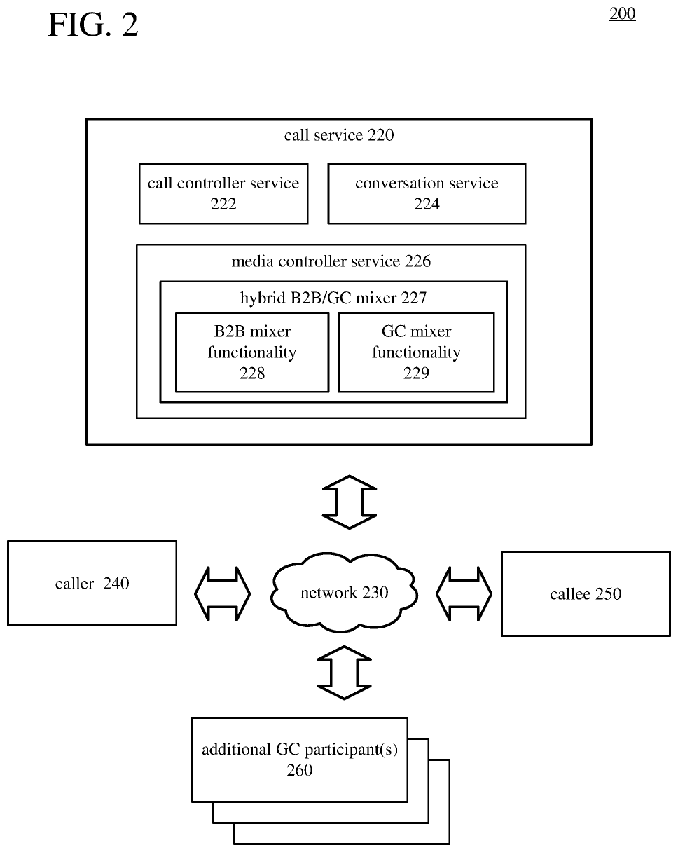

FIG. 2 shows an example network environment (200) that includes a call service (220). Call service (220) connects to a plurality of entities over a network (230) using an appropriate communication protocol. These entities include a caller (240), a callee (250), and at least one GC participant (260). Network (230) can be the Internet or another computer network.

Call service (220) can be implemented using software and/or hardware resources (e.g., computer servers, cloud computing resources, software resources, etc.), and can include software and/or hardware resources that communicate with call participants' client devices (e.g., client devices of caller (240), callee (250), and client devices of any other additional GC participants (260). Further, call service (220) can perform audio and/or video mixing and other call operations. As used herein, the term “call” refers to a call or meeting involving two or more client devices, such as a conference call.

The client devices (e.g., the devices for caller (240), callee (250), and any additional GC participant devices) can include computing devices (e.g., desktop computers, laptop computers, tablets, smart phones, etc.) as well as Public Switched Telephone Network (PSTN) entities. In some examples, a call managed by call service (220) also includes one or more additional entities such as recording applications for compliance recording. Such applications can be hosted on the server side or the client side. Instances of the term “call” herein should be understood as referring to a conference call, which may be a video call (including audio and video) or an audio-only call.

Call service (220) includes a call controller service (222), a conversation service (224), and a media controller service (226). Call controller service (222) handles the routing of calls and makes runtime decisions on whether calls should be elevated. Conversation service (224) serves as the entry point for establishing a call using call service (220) and manages the overall conversation between participants of a call. For example, in the process of routing a call, call controller service (222) can determine whether the call should be elevated based on a variety of factors, such as checking whether either the caller or the callee seeks recording applications in the call. Then, upon determining that elevation should be performed, call controller service (222) can pause call setup and bootstrap a hybrid B2B/GC mixer via media controller service (226), as discussed further below.

Media controller service (226) manages media signaling and can be configured to act as an intermediary between call participants. In some examples, media controller service (226) can facilitate communications between call participants using different platforms. For example, when a caller initiates a call with the call service to a callee that is a PSTN entity (e.g., a user of an analog telephone), media controller service (226) can translate Voice over Internet Protocol (VOIP) communications from the call service such that it can be understood by the PSTN Session Border Controller. As discussed further below, media controller service (226) can spawn a hybrid B2B/GC mixer (227) which includes B2B mixer functionality (228) as well as GC mixer functionality (229).

Caller (240) can be any entity capable of initiating a call via call service (220). For example, caller (240) can be a client computing device that subscribes to call service (220). Callee (250) can be any entity capable of receiving a call initiated by call service (220). In some examples, callee (250) is a Public Switched Telephone Network (PSTN) entity. The PSTN is a global telecommunications network that provides traditional voice communication services using circuit-switched technology. In other examples, callee (250) is a client computing device that subscribes to call service (220), similar to caller (240).

GC participant(s) (260) can be any entity capable of participating in a call hosted by call service (220). GC participant(s) (260) can include one or more recording applications added to calls by the call service (220) to provide compliance recording functionality. For example, the caller, callee, or another user participating in the call can be associated with a policy (e.g., a compliance recording policy) that includes a condition that a recording application participate in the call to record call media. Further, GC participant(s) (260) can include one or more client computing devices that subscribe to call service (220), and/or one or more PSTN entities.

### III. Hybrid B2B/GC Mixer.

As discussed above, hybrid B2B/GC mixer (227) combines the functionality of a GC mixer and a B2B mixer. A GC mixer, also known as a video conferencing mixer or a video mixer, is a device or software application that mixes audio and video and broadcasts it to all participants. In particular, GC mixers may combine multiple audio and/or video streams from different participants of a call to allow the participants to see and interact with each other's video feeds simultaneously. In some examples, a GC mixer mixes audio streams from participants but does not mix video streams from the participants; instead, the video streams remain separate so that clients can subscribe to each video stream independently. In other examples, a GC mixer includes functionality to merge and synchronize the audio and/or video streams from the various participants, such as webcams or dedicated video conference systems, into a single composite video output. This composite video feed can then be displayed on a shared screen or transmitted to all participants in the call.

GC mixers can suffer from drawbacks when employed in certain circumstances. For example, when a call is hosted by a normal GC mixer, early media flow is not supported, and thus any features and experiences enabled via early media flow are not available when elevation via a normal GC mixer is used. In particular, in a normal GC mixer, the caller and callee's “legs” are independent such that in either the caller or the callee will connect to the mixer first during call setup. Accordingly, depending upon implementation and/or chance, the caller or the callee might have a strange user experience which is inconsistent with the fact that the caller has directly called the callee. For example, the caller's call setup might complete very fast because the mixer will “answer” almost immediately, at which point the caller would feel like the call was answered (e.g., ringing would stop, the user interface (UI) would change). If using a calling application, the caller would see the call as connected potentially before the callee even started ringing. If the caller is connected before the callee, the caller would hear silence until the callee starts sending early media or, if no early media is used, until the callee connects as well. In contrast, the desired behavior is for the caller to hear ringing up until the callee starts sending early media or answers the call. As another example, a situation where the callee starts sending media (early or not) before the caller is able to receive it can lead to clipped audio.

To avoid the above issues, hybrid mixer (227) includes B2B mixer functionality (228) as well as GC mixer functionality (228). B2B mixer functionality (228) describes a specific set of operations that can be performed by hybrid mixer (227) such that the experience of the caller and callee mimics that of a P2P call. In particular, B2B mixer functionality (228) enables the hybrid mixer (227) to operate as a B2B agent between the caller and callee, such that the call signaling follows a one-to-one flow and the call setup only completes when the callee answers the call.

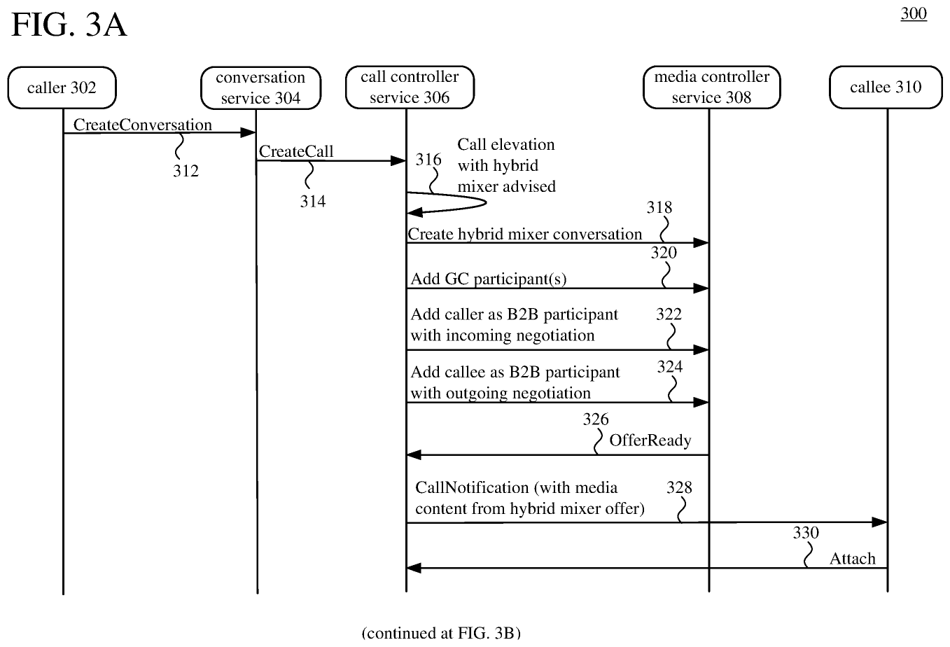

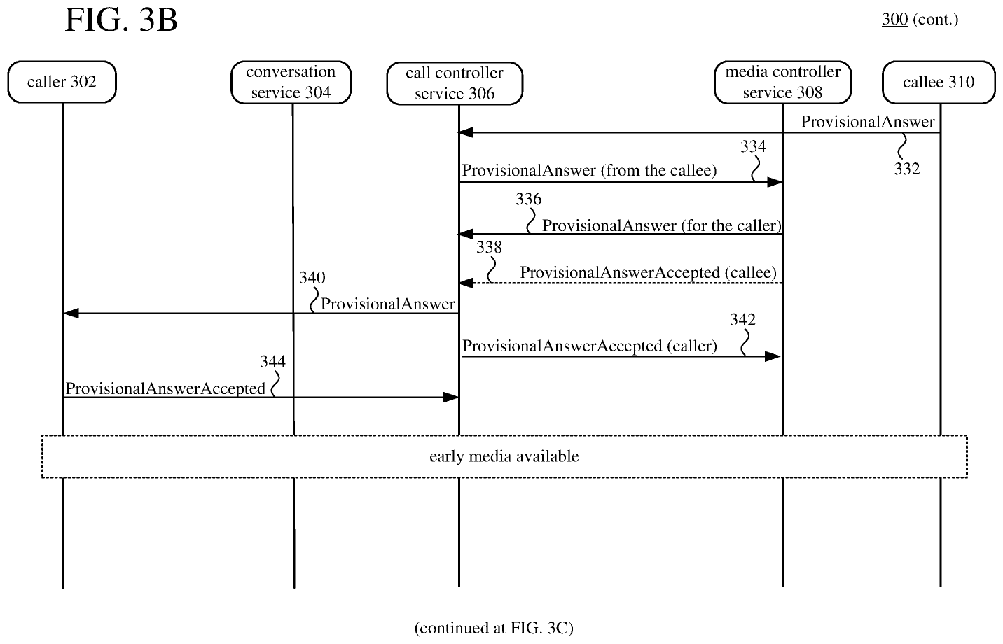

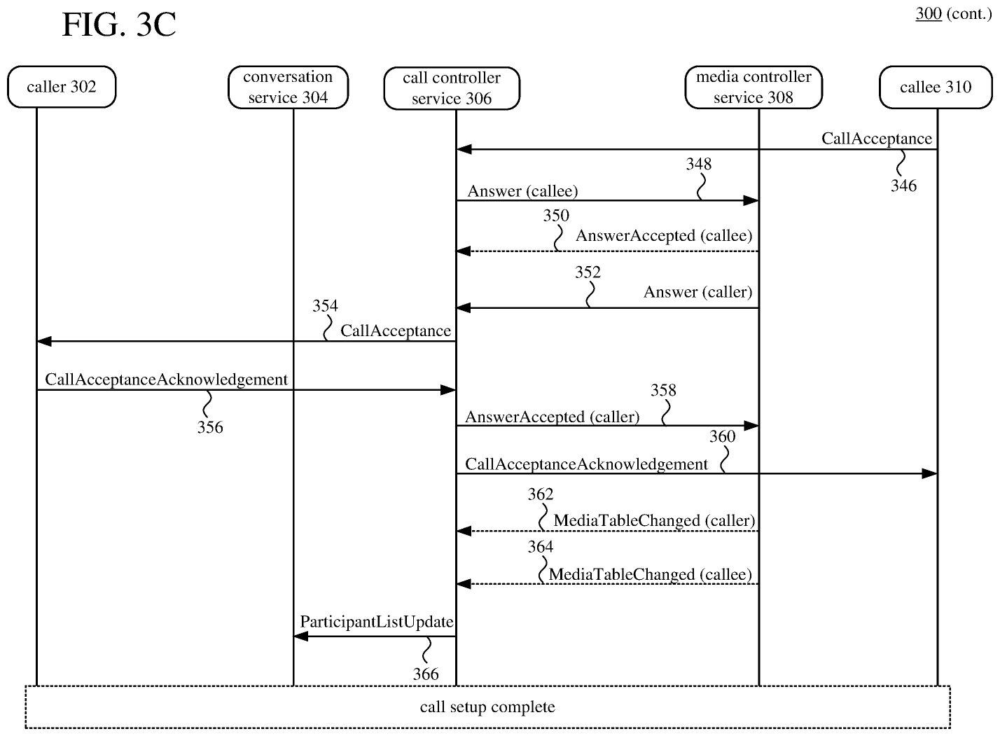

The set of operations described by B2B mixer functionality (228) can include the hybrid mixer (227) being inserted in between two peers (e.g., the caller and callee) to receive signaling information from one peer, modify the signaling information so that it can be understood by the other peer, and then send it to the other peer, as detailed below with reference to FIGS. 3A-C. From the peer's perspective, it looks like they are only communicating with the other peer and not through a mixer. Since the hybrid mixer relays the operation from one peer to the other, it is acting as a B2B agent (e.g., acting as an intermediary between the peer by sitting in the middle of the communication flow and relaying information between the peers).

Example operations included in B2B mixer functionality can include call control, e.g., management of the setup, coordination, and termination of a P2P call. Call control can also include handling signaling protocols, call routing, and call state management. B2B mixer functionality can also include operations for media handling, e.g., processing and modification of media streams exchanged between the call participants. Media handling can include transcoding, encryption, decryption, packet inspection, or modification of audio or video content, for example. In some examples, B2B mixer functionality (228) can provide interoperability between two (and only two) peers that are attempting a one-to-one call with each other but are incompatible (e.g., a PSTN number and a call service client device).

GC mixer functionality (229) describes a specific set of operations that can be performed by hybrid mixer (227) to enable the media controller service (226) to add one or more additional entities, beyond the caller and callee, to a call. In particular, these operations can include adding the one or more additional entities as regular GC participants which are not part of the B2B relationship shared by the caller and callee. The one or more additional entities can include one or more recording applications (sometimes referred to as “recording bots”) which perform policy-based recording of calls. The one or more additional entities can also include one or more client devices of additional call participants (e.g., users) which are not recording applications.

Notably, a typical GC mixer is not compatible with a typical B2B mixer (e.g., they do not share the same Application Programming Interfaces (APIs)/possible operations). For example, when a media controller service operates in a GC mixer mode, it cannot perform the operations of a B2B mixer (e.g., adding a B2B participant to a call, propagating provisional answers, etc.) Similarly, when a media controller service operates in a B2B mixer mode, it cannot perform the operations of a GC mixer (e.g., adding a third entity to a call as a GC participant). In contrast, the hybrid mixer disclosed herein provides an operating mode for a media controller service which combines both sets of operations (e.g., GC mixer operations for adding GC participants and B2B mixer operations for adding B2B participants). Put another way, a media controller service operating in the hybrid B2B/GC mixer mode can perform operations typically associated with a dedicated B2B mixer as well as operations typically associated with a dedicated GC mixer.

As discussed further below with reference to FIGS. 3A-C, a specialized form of call elevation can be achieved by adding the original caller and callee to hybrid mixer (227) while adding other group call participants, such as recording applications, as regular GC participants which are not part of the B2B relationship. As a result, all participants present at the beginning of the call (including the caller, callee, and added participants such as recording applications) are able to hear any early media provided by the callee. Accordingly, in contrast to prior approaches, features that rely on or are optimized by call elevation can function with early media flow.

As used herein, “early media” refers to the audio or video content that is sent to call participants before the actual call is fully established or before the called party has answered the call. Early media can include custom ringing, automated IVR, Dual-Tone Multi-Frequency (DTMF) input, etc. As one non-limiting example, early media can include an automated IVR system playing a message which includes prompts for the caller or callee to respond to with DTMF input.

IV. Example Processing Flows for Call Elevation with a Hybrid B2B/GC Mixer.

This section describes innovations in call elevation performed by a call service employing a hybrid mixer which combines the functionality of a GC mixer and a B2B agent.

FIGS. 3A-C collectively form an example processing flow (300) including signals exchanged among the sub-services of a call service (e.g., call service (220) of FIG. 2) and a caller and callee. In particular, as shown, signals are exchanged among a caller (302), a conversation service (304), a call controller service (306), a media controller service (308), and a callee (310).

Referring to FIG. 3A, caller (302) sends a CreateConversation signal (312) to conversation service (304) to start a call. Conversation service (304) then sends a CreateCall signal (314) to call controller service (306), so as to bootstrap call controller service (306). As used herein, the term “bootstrap” can refer to invoking an API on a service or sending a HyperText Transfer Protocol (HTTP) request to a service, which causes a session to be created on that service for something to happen. During the process of routing the call, call controller service (306) determines whether elevation of the call with a hybrid B2B/GC mixer is necessary. As discussed above, the term “elevation” is typically used to describe transitioning a call between a caller and a callee into a multiparty call hosted by a GC mixer during call setup (e.g., before a peer-to-peer connection between the caller and callee has been established). Elevation can be used to add additional participants into a call; these additional participants can be users of client devices subscribing to the call service or entities such as recording applications. It will be appreciated that the process of elevating a call with a hybrid B2B/GC mixer is different than the regular process of elevating a call, aside from the fact that in both processes a mixer is introduced into the call during call setup between a caller and callee that would have normally been connected with a peer-to-peer connection.

The determination of whether to elevate the call with a hybrid B2B/GC mixer can be based on a variety of factors. These factors can depend on the scenario of the call and what features are active (e.g., whether a policy of the caller and/or callee has a condition that a recording application participate in the call). For example, call controller service (306) can determine whether the caller and/or callee is subject to a compliance recording policy that dictates that recorders need to be added to their calls, and if so, determine that elevation of the call is advised. As another example, call controller (306) can determine that call elevation with a hybrid B2B/GC mixer is advised when it is necessary to ensure that early media flow is available on the call.

While not depicted in processing flow (300), in some examples, call controller service (306) may determine that elevation of the call with a regular GC mixer, rather than a hybrid B2B/GC mixer, is appropriate. For example, elevation with a regular GC mixer may be desired when it is determined that the caller is calling a first-party call queue service (e.g., a service designed to manage incoming calls efficiently and ensure a smooth experience for callers). First-party call queue services may necessarily involve adding another call queue a few seconds later (e.g., elevating the call up front).

In the depicted example, call controller service (306) determines at (316) that call elevation with a hybrid B2B/GC mixer is advised. Call controller service (306) then pauses call setup and bootstraps a hybrid B2B/GC mixer (e.g., hybrid mixer (227) of FIG. 2) via media controller service (308). In particular, call controller service (306) sends a signal (318) to media controller service (308) to request creation of a hybrid B2B/GC mixer conversation.

Once the hybrid mixer conversation is ready, call controller service (306) adds any additional participants (e.g., recording applications) that need to be present on the hybrid mixer before the original caller and callee may communicate at (320). The process of adding additional group call participants may include several steps (e.g., multiple signals sent between call controller service (306), media controller service (308), and possibly other services), which are not described herein for the sake of brevity. These participants are added as GC participants, rather than B2B participants, and thus do not share a B2B relationship with any other participants of the call.

Call controller service (306) then adds the caller and the callee sequentially to the hybrid mixer, specifying for each participant that it is a caller/callee B2B participant. In particular, call controller service (306) sends a signal (322) instructing media controller service (308) to add the caller to the hybrid mixer as a B2B participant with an incoming negotiation. Signal (322) also contains a media offer for the caller. Call controller service (306) then sends a signal (324) instructing media controller service (308) to add the callee to the hybrid mixer as a B2B participant with an outgoing negotiation. The hybrid mixer of media controller service (308) then creates a logical relationship between the caller and callee as call setup continues.

Next, media controller service (308) sends an OfferReady signal (326) to call controller service (306), which includes the media offer for the callee from the hybrid mixer. Call controller service (306) then replaces the media offer from the caller with the media offer from the mixer and includes that media offer in a call notification request to be sent to callee (310). Call controller service (306) then sends a signal (328) to callee (310) which includes the call notification request (“CallNotification”) and media content from the hybrid mixer offer (e.g., the media offer originally sent by media controller service (308) in signal (326)). After receiving signal (328), callee (310) sends a signal (330) including an Attach message to call controller service (306). The Attach message indicates that callee (310) has received the call notification indicating that the callee is an eligible endpoint for the call.

Processing flow (300) continues in FIG. 3B. At this stage, the callee sends a provisional answer request (e.g., containing Session Description Protocol (SDP) information) back to the caller in order to enable early media to flow between the two participants. To accomplish this, the callee sends a signal (332) to call controller service (306) which includes a ProvisionalAnswer message. Call controller service (306) then sends a signal (334) including the Provisional Answer message from the callee to media controller service (308), so as to feed this message to the hybrid mixer of media controller service (308). The hybrid mixer then processes the message (e.g., examines the message, removes and replaces or fixes any inconsistencies or known issues that the caller would have trouble interpreting). After processing the message, the hybrid mixer generates a provisional answer for the caller which is based on the (processed) provisional answer from the callee.

Media controller service (308) then sends a signal (336) to call controller service (306) which contains the generated provisional answer for the caller. Media controller service (308) also sends a signal (338) including a ProvisionalAnswerAccepted message to call controller service (306). In the depicted example, signal (338) is represented by a dotted line because it is independent of the preceding signal (336) and does not result in any further requests within processing flow (300).

Next, call controller service (306) forwards the ProvisionalAnswer message to caller (302) via signal (340). Call controller service (306) then sends a signal (342) including a Provisional AnswerAccepted message for the caller to media controller service (308). Subsequently, caller (302) sends a signal (344) including a Provisional AnswerAccepted message to call controller service (306). This message serves to acknowledge the provisional answer that was originally sent by the callee. At this point, as indicated, early media can flow between the caller and callee and is also available for other call participants. Accordingly, features such as custom ringing, automated IVR, and Dual-Tone Multi-Frequency (DTMF) input are now functional.

Processing flow (300) continues in FIG. 3C to complete the call setup process. First, the callee officially accepts the call (e.g., the associated user clicks an “accept” icon in a UI of the call service to answer the call or answers the call using a mobile device or analog phone). On a lower level, this entails the callee sending a non-provisional (e.g., final) answer to the caller, which is similarly fed via the call controller service to the hybrid mixer which in turn will provide an answer to be sent to the caller. In particular, callee (310) sends a signal (346) including a CallAcceptance message to call controller service (306), which then sends a signal (348) including an Answer for the callee to media controller service (308). Media controller service (308) then sends a signal (350) containing an AnswerAccepted message for the callee to call controller service (306), and subsequently sends a signal (352) including an Answer message for the caller to call controller service (306). In the depicted example, signal (350) is represented by a dotted line because it is independent of the following signal (352) and does not result in any further requests within processing flow (300).

Call controller service (306) then sends a signal (354) including a CallAcceptance message to caller (302), and caller (302) responds by sending a signal (356) including a CallAcceptanceAcknowledgement message to call controller service (306). Call controller service (306) then sends a signal (358) including an AnswerAccepted message for the caller to media controller service (308), and subsequently sends a signal (360) including a CallAcceptanceAcknowledgement message to callee (310), thereby acknowledging the caller's answer accepting the call.

Accordingly, the callee's call acceptance message travel in a similar manner to the provisional answer before being received by the caller. That is, the acceptance first gets sent to the hybrid mixer of the media controller service, which then sends out an appropriate answer, which is equivalent here to acceptance. That acceptance carries the SDP information for the acceptance, which travels all the way back to the caller. The caller acknowledges that acceptance.

Returning to FIG. 3C, following call acceptance, the hybrid mixer of media controller service (308) provides media tables for each user. In particular, media controller service (308) first sends a signal (362) including a MediaTableChanged request for the caller to call controller service (306), and then sends a signal (364) including a MediaTableChanged request for the callee to call controller service (306). MediaTableChanged requests can include metadata on the media information for each user in the call. In the depicted example, signals (362) and (364) are represented by dotted lines as they are sent by the media controller service independently after the users are added to the mixer.

After receiving the MediaTableChanged requests for the caller and callee, controller service (306) sends a signal (366) including a ParticipantListUpdate message to conversation service (304). The ParticipantListUpdate message can contain metadata for all the users in the call, which conversation service (304) can subsequently fork out to all the users in the call (e.g., in the form of a roster). As shown, call setup is complete after the participant list update is performed.

As used herein, the term “message” can refer to the content of the message. For example, description herein of a message being processed, sent, or received by different entities can refer to the message's content, even if other aspects of the message (e.g., fields, headers, etc.) are added, removed, or modified at different stages. In some implementations, messages are exchanged among the various entities of the call service without their contents being modified. For example, a message sent from caller (302) to conversation service (304) can be forwarded with its contents in their original, unmodified form from conversation service (304) to call controller service (306). Call controller service (306) can then forward that message with its contents unchanged to media controller service (308), and media controller service (308) can then forward the message, without modifying its contents in any way, to callee (310). The various services of the call service may, however, add fields or headers to the messages, or otherwise repackage the messages, without affecting the messages' contents. In other examples, no repackaging or modification of the messages whatsoever is performed by these services.

V. Example Approaches for Call Elevation with a Hybrid B2B/GC Mixer.

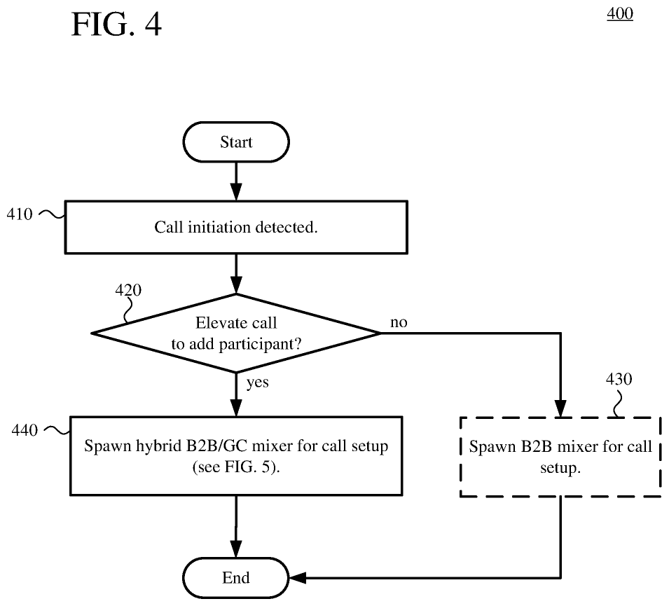

FIG. 4 shows a generalized technique (400) for call elevation with a hybrid B2B/GC mixer. A call service including a media controller service configured to spawn a hybrid B2B/GC mixer, as described with reference to FIGS. 2-3 or otherwise, can perform the technique (400).

To start, initiation of a call from a callee to a caller is detected (410). As shown in FIG. 3A, this can include the caller sending a CreateConversation request to a conversation service of the call service, which in turn sends a CreateCall request to a call controller service of the call service. The call service then determines whether to elevate (420) the call in order to add a participant to the call. The participant can be a non-user entity such as a recording application, or a user client device configured to participate in calls. If it is determined not to elevate the call (e.g., it is not necessary to add a participant to the call), a B2B mixer is optionally spawned (430) for call setup. For example, a media controller service of the call service can spawn (e.g., bootstrap) a B2B mixer which can serve as a B2B agent for the caller and callee for the remainder of the call setup process.

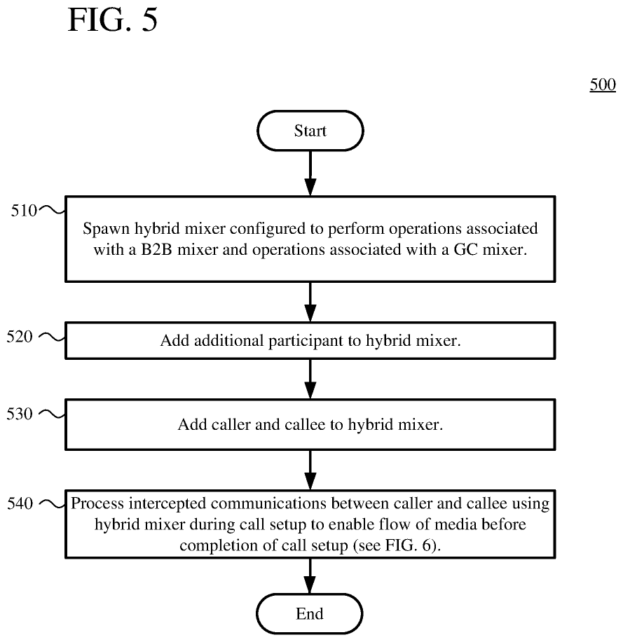

Returning to (420), if it is instead determined to elevate the call to add a participant to the call, a hybrid B2B/GC mixer is spawned (440) for call setup, as described further below with reference to FIG. 5. After this step, technique (400) ends.

FIG. 5 shows another generalized technique (500) for call elevation with a hybrid B2B/GC mixer. A call service including a media controller service configured to spawn a hybrid B2B/GC mixer, as described with reference to FIGS. 2-3 or otherwise, can perform the technique (500). In some examples, technique (500) can be initiated at step (420) of technique (400).

To start, a hybrid mixer configured to perform operations associated with a B2B mixer and operations associated with a GC mixer is spawned (510). For example, the media controller service can internally spawn (e.g., create or initialize) a hybrid mixer which includes B2B mixer functionality as well as GC mixer functionality to participate in setup of the call. The hybrid mixer can perform operations typically performed by a dedicated B2B mixer as well as operations typically performed by a dedicated GC mixer.

An additional participant is then added (520) to the hybrid mixer. The additional participant can be a recording application or another call participant (user). In some examples, the additional participant is added as a GC participant. When a participant is added as a GC participant, the participant does not have a B2B relationship with any other call participants. In some examples, multiple additional participants can be added at this stage as GC participants.

Next, the caller and callee are added (530) to the hybrid mixer. In some examples, the caller and callee are added as B2B participants. For example, as discussed above with reference to FIG. 3A, the call controller service can first instruct the media controller service to add the caller to the hybrid mixer as a B2B participant with an incoming negotiation, and then instruct the media controller service to add the callee to the hybrid mixer as a B2B participant with an outgoing negotiation. In some examples, the caller and callee are sequentially added to the hybrid mixer (e.g., the caller is added, and then the callee is added). In other examples, the callee could be added before the caller, or the caller and callee could be added at the same time (e.g., simultaneously).

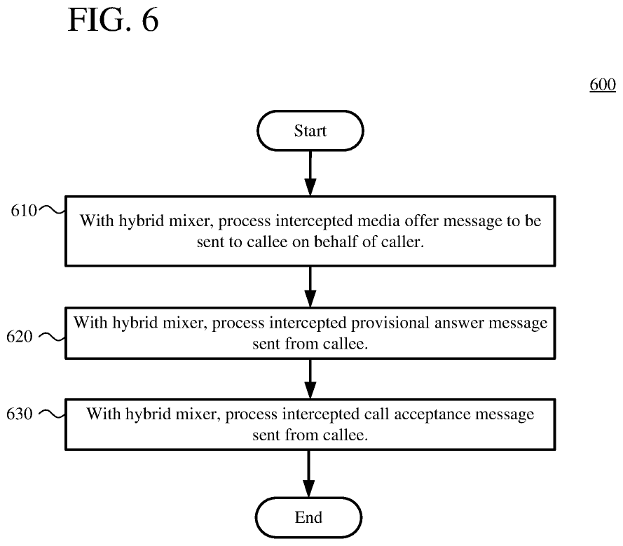

The hybrid mixer of can then maintain a B2B relationship between the caller and callee as call setup continues. Towards this end, the hybrid mixer can process (540) intercepted communications between the caller and callee during call setup, as described further below with reference to FIG. 6, to enable early media flow. After this step, technique (500) ends.

FIG. 6 shows yet another generalized technique (600) for call elevation with a hybrid B2B/GC mixer. A call service including a media controller service configured to spawn a hybrid B2B/GC mixer, as described with reference to FIGS. 2-3 or otherwise, can perform the technique (500). In some examples, technique (600) can be initiated at step (540) of technique (500).

To start, the hybrid mixer processes (610) an intercepted media offer message to be sent to the callee on behalf of the caller. Next, the hybrid mixer processes (620) an intercepted provisional answer message sent from the callee. Once the provisional answer message has been conveyed to the caller, flow of media (e.g., early media) is available for the call participants. The hybrid mixer then processes (630) an intercepted call acceptance message sent from the callee. After this step, technique (600) ends.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. In a computing system, a method of elevating a call, the method comprising:
detecting that a caller has initiated a call to a callee on a call service hosted by the computing system;
determining whether to add an additional participant to the call;
responsive a determination to add the additional participant:
spawning a mixer configured to mediate communications between the caller and the callee, but not between the caller and the additional participant or between the callee and the additional participant, to emulate a peer-to-peer connection between only the caller and the callee/or video;
during setup of the call, adding the additional participant, the caller, and the callee to the mixer, wherein adding the caller and the callee to the mixer comprises using the mixer to intercept and process communications between the caller and the callee to emulate the peer-to-peer connection between the caller and the callee, and wherein, during the setup of the call, the mixer does not intercept and process communications between the caller and the additional participant or communications between the callee and the additional participant; and
after adding the additional participant, the caller, and the callee to the mixer, enabling flow of media between the caller, the callee, and the additional participant before completion of the setup of the call.

2. The method of claim 1, wherein determining to add the additional participant to the call comprises determining that a recording policy of the caller and/or the callee includes a condition that a recording application be added to the call as a participant.

3. The method of claim 1, wherein the media is early media comprising audio and/or video content that is sent to one or more participants of the call during the setup of the call, before the call is fully established.

4. The method of claim 1, wherein the communications between the caller and the callee comprise:
a media offer message sent to the callee on behalf of the caller;
a provisional answer message sent from the callee; and
a call acceptance message sent from the callee.

5. The method of claim 4, wherein the communications between the caller and callee further comprise a provisional answer accepted message sent from the caller after the caller has received the provisional answer message, wherein the flow of media is enabled after the caller sends the provisional answer accepted message and before completion of the setup of the call.

6. The method of claim 5, wherein the media comprises interactive voice response (IVR) prompts and/or ringtones.

7. The method of claim 1, wherein the mixer is internally spawned by a media controller service of the call service, wherein the call service further comprises a conversation service and a call controller service, and wherein at least the media controller service and the call controller service collectively process the communications between the caller and the callee during the setup of the call.

8. A computer system comprising a processing system and memory, wherein the computer system is configured to perform operations for elevating a call, the operations comprising:
detecting that a caller has initiated a call to a callee on a call service hosted by the computer system;
determining whether to add an additional participant to the call;
responsive to a determination to add the additional participant:
spawning a mixer configured to mediate communications between the caller and the callee, but not between the caller and the additional participant or between the callee and the additional participant, to emulate a peer-to-peer connection between only the caller and the callee;
during setup of the call, adding the additional participant, the caller, and the callee to the mixer, wherein adding the caller and the callee to the mixer comprises using the mixer to intercept and process communications between the caller and the callee to emulate the peer-to-peer connection between the caller and the callee, and wherein, during the setup of the call, the mixer does not intercept and process communications between the caller and the additional participant or communications between the callee and the additional participant; and
after adding the additional participant, the caller, and the callee to the mixer, enabling flow of media between the caller, the callee, and the additional participant before completion of the setup of the call.

9. The computer system of claim 8, wherein the call is a first call, and wherein the operations further comprise:
determining whether to add an additional participant to a second call, different than the first call; and
responsive to a determination not to add the additional participant to the second call, spawning a mixer configured to intercept and process communications between a caller and a callee of the second call during setup of the second call.

10. The computer system of claim 8, wherein the mixer is further configured to maintain a back-to-back (B2B) relationship between the caller and the callee during the setup of the call.

11. The computer system of claim 10, wherein the additional participant GC participant which is not part of the B2B relationship shared by the caller and the callee, and wherein the additional participant comprises a recording application.

12. The computer system of claim 8, wherein the additional participant comprises a client device of a user.

13. The computer system of claim 8, wherein using the mixer to intercept and intercepted communications between the caller and the callee during the setup of the call comprises processing a provisional answer message sent from the callee using the mixer.

14. The computer system of claim 13, wherein the media is early media comprising audio and/or video content that is sent to one or more participants of the call during the setup of the call, before the call is fully established, and wherein the early media is available to the caller, the callee, and the additional participant, as part of the flow of the early media, after receiving a provisional answer accepted message from the caller after the caller has received the provisional answer message.

15. The computer system of claim 14, wherein the early media comprises interactive voice response (IVR) prompts and/or ringtones.

16. The computer system of claim 8, wherein the mixer is internally spawned by a media controller service of the call service, wherein the call service further comprises a conversation service and a call controller service configured to cooperate with the media controller service to collectively intercept and process communications between the caller and the callee during the setup of the call.

17. A non-transitory computer-readable medium having stored thereon computer-executable instructions for causing a processing system, when programmed thereby, to perform operations comprising:
detecting that a caller has initiated a call to a callee on a call service implemented using the processing system;
determining whether to elevate the call to add a recording application as an additional participant of the call;
responsive to a determination to elevate the call to add the recording application as the additional participant of the call:
using a media controller service of the call service to internally spawn a mixer configured to mediate communications between the caller and the callee, but not between the caller and the recording application or between the callee and the recording application, to emulate a peer-to-peer connection between only the caller and the callee;
during setup of the call, adding the recording application, the caller, and the callee to the mixer, wherein adding the caller and the callee to the mixer comprises using the mixer to intercept and process communications between the caller and the callee to emulate the peer-to-peer connection between the caller and the callee, and wherein, during the setup of the call, the mixer does not intercept and process communications between the caller and the recording application or communications between the callee and the recording application; and
after adding the recording application, the caller, and the callee to the mixer, enabling flow of media between the caller, the callee, and the recording application before completion of setup of the call.

18. (canceled)

19. The non-transitory computer-readable medium of claim 17, wherein the communications exchanged between the caller and the callee during the setup of the call comprise a provisional answer message sent by the callee and a provisional answer accepted message sent by the caller, and wherein the media is available to the caller, the callee, and the recording application, as part of the flow of the media, after receiving, from the caller, the provisional answer accepted message.

20. The non-transitory computer-readable medium of claim 17, wherein the recording application is configured to perform compliance recording of the call.

21. The method of claim 1, wherein during the setup of the call, the additional participant is added to the mixer and then the caller and the callee are added to the mixer.
